(19) United States
(12) Patent Application Publication
(10) Pub. No.: US 2006/0253601 A1
(43) Pub. Date: Nov. 9, 2006

(54) Scheduling client feedback during streaming sessions

(75) Inventors: Ramakrishna Vedantham, Irving, TX (US); Igor Curcio, Tampere (FI); David Leon, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/416,035

(22) Filed: May 2, 2006

Related U.S. Application Data
(60) Provisional application No. 60/677,426, filed on May 3, 2005.

(51) Int. Cl. G06F 15/16

(52) U.S. Cl. 709/231

(57) ABSTRACT

The systems and methods include scalable feedback during point-to-multicast (PtM) streaming sessions with user feedback during a broadcast/multicast streaming session. The method of providing scalable feedback during PtM streaming sessions can include communicating data from a sender to at least one receiver and communicating feedback from at least one of the at least one receiver to the sender during a multimedia streaming session.

### CROSS REFERENCE TO RELATED APPLICATIONS

This application is a an application claiming the benefit under 35 USC 119(e) U.S. Provisional Application 60/677,426, filed May 3, 2005, incorporated herein by reference in its entirety.

### BACKGROUND OF THE INVENTION

1. Field of the Invention

The present invention relates generally to Multimedia Broadcast/Multicast Service (MB/MS) streaming services. More specifically, the present invention relates to mechanisms for scheduling and transport of limited user feedback during an MB/MS streaming session.

2. Description of the Related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Multimedia Broadcast/Multicast Service (MB/MS) streaming services facilitate resource efficient delivery of popular real-time content to multiple receivers in a 3G mobile environment. Instead of using different point-to-point (PtP) bearers to deliver the same content to different mobiles, a single point-to-multipoint (PtM) bearer is used to deliver the same content to different mobiles in a given cell. The streamed content may consist of video, audio, SVG, timed-text and other supported media. The content may be pre-recorded or generated from a live feed.

A variety of proposals have been made for delivery procedures, including PtP repair after a file download session and content delivery verification reports after download or streaming sessions. In the case of download sessions, the content delivery verification reports may contain details of successfully downloaded files. In case of streaming sessions, the content delivery verification reports contain QoE metrics. U.S. patent application Ser. No. 10/782,371 entitled “DATA REPAIR” filed on Feb. 18, 2004, having the same assignee as the present application, and herein incorporated by reference, describes a mechanism for reducing network overload caused by simultaneous PtP repair requests and content delivery verification reports. It recommends the use of random back-off time and random repair server selection. It also defines the signalling of associated parameters i.e., maximum back-off time and a list of servers that handle the repair or verification reports. However, none of these proposed mechanisms deal with user feedback during the MBMS streaming session.

User feedback during a broadcast/multicast streaming session is a desirable feature that can facilitate interactive programming on mobile TVs or MBMS terminals. However, current MBMS specifications do not specify mechanisms for user feedback during MBMS streaming sessions. Simultaneous user feedback from multiple MBMS clients can result in feedback implosion problems at the server and may overload/block the network resources.

Thus, there is a need for mechanisms for scheduling and transport of limited user feedback during an MBMS streaming session. Further, there is a need for relevant signaling information for scheduling client feedback during broadcast or multicast streaming sessions.

### SUMMARY OF THE INVENTION

In general, the present invention relates to scalable feedback during point-to-multicast (PtM) streaming sessions. User feedback during a broadcast/multicast streaming session is a desirable feature that can facilitate interactive programming on mobile TVs or MBMS terminals. Such feedback can include, for example, the following: (1) mobile TV viewers voting during the reality shows, (2) changing the content of the next streaming session based on the votes received during the current streaming session, and (3) animation in SVG (scalable vector graphics) content that prompts user interaction where user response needs to be sent to the server within a certain time

One exemplary embodiment relates to a method of providing scalable feedback during point-to-multicast (PtM) streaming sessions. The method can include communicating data from a sender to at least one receiver and communicating feedback from at least one of the at least one receiver to the sender during a multimedia streaming session.

Other exemplary embodiment relates to systems, computer programs, and devices to provide scalable feedback during PtM streaming sessions.

### BRIEF DESCRIPTION OF DRAWINGS

FIG. 1 is a diagram illustrating a one-to-many data transmission scenario in accordance with an exemplary embodiment.

FIG. 2 is a diagram illustrating the meaning of ‘waitTime’ and ‘maxBackOff’ parameters in accordance with an exemplary embodiment.

FIG. 3 is a diagram illustrating a receiver device in accordance with an exemplary embodiment.

FIG. 4 is a diagram illustrating a sender device in accordance with an exemplary embodiment.

### DETAILED DESCRIPTION OF EXEMPLARY EMBODIMENTS

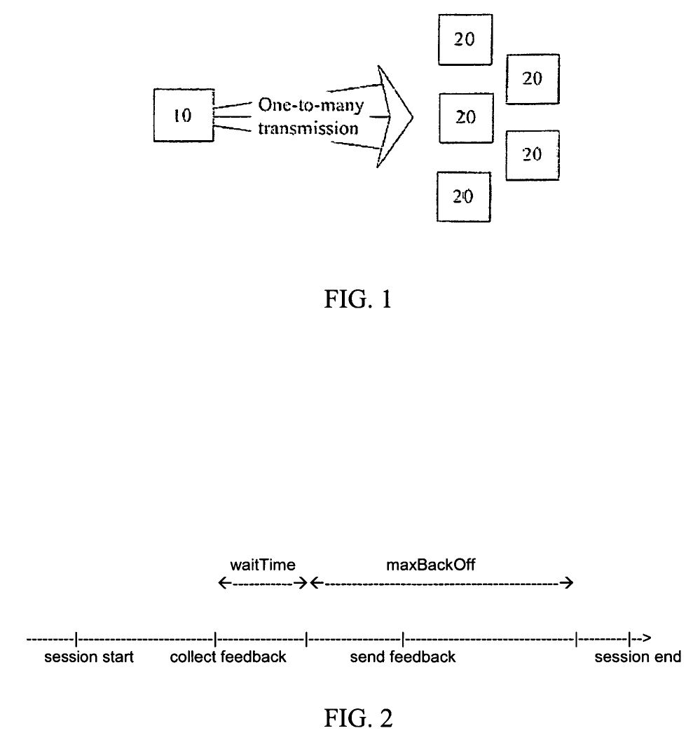

FIG. 1 illustrates a one-to-many data transmission scenario in accordance with an exemplary embodiment. The sender device 10 is a server, IP-based device, DVB device, GPRS (or UMTS) device or similar device that may use proactive forward error correction, such as an ALC (asynchronous layered coding) mechanism and/or FEC (forward error correction) mechanism, for sending multicast data blocks (or packets) to receiver devices 20 in a one-to-many fashion. Each receiving device 20 sends negative acknowledgement (NACK) messages (or requests) to the sender device 10 concerning missing blocks (blocks not received or received incorrectly). In response to NACK message(s), the sender device 10 generally re-transmits missing blocks to the receiver device 20 in a FLUTE (file delivery over unidirectional transport) session (the same session as the original FLUTE session established for original transmission, or a subsequent FLUTE session). Alternatively, a session using another protocol than FLUTE may be used.

Data is transferred from sender 10 to receiver(s) 20 as objects. For instance, a file, a JPEG image, a file slice are all objects. A session is established between the sender device 10 and the receiver device(s) 20 for file (or data) delivery. A single session may include the transmission of a single object or multiple objects. Different identifiers are used to identify the objects and sessions.

Each data block has a number called source block number (SBN) or similar, which identifies each block. Blocks are represented by a set of encoding symbols. An encoding symbol identifier (ESI) or similar, in turn, indicates how the encoding symbols carried in the payload of a data packet (or block) were generated from the above-mentioned object (e.g., file).

The exemplary embodiments provide for scalable feedback during point-to-multicast (PtM) streaming sessions. These exemplary embodiments can be implemented using application/content driven feedback, extensions to associated delivery procedures in MBMS, and RTCP feedback reports.

The following is an example application/content driven feedback implementation. If the PtM streaming content needs user feedback during the session, then the PtM server describes the related parameters out of band (e.g., in the SDP file corresponding to the associated delivery procedures.) A minimal set of such parameters includes (1) a set of URIs of the servers that collect the feedback and (2) maximum back off time for random time dispersion (‘maxBackOff’).

During the MBMS streaming session, a client application or SVG animation may prompt for user input e.g., select yes/no, select the best, rank the top three etc. The application collects the user input as soon as it is provided (say at time=‘feedback_time’) and stores it in a buffer for a scheduled transport to a feedback collection server. The transport scheduler in the client generates a random number ‘X’ between ‘0’ and ‘maxBackoff’. Then it computes Actual_transport_time=feedback_time+X. A feedback collection server is selected at random from the set of URIs signaled in advance in SDP. When current_time=‘actual_transport_time’, a TCP connection is established to the randomly selected URI. The user response is embedded in an XML object which is sent using HTTP POST method.

The user feedback can be formatted in an XML object. The XML object includes the necessary parameters to identify the feedback, streaming session and the client ID. The application-specific feedback is included in the XML object by specifying extensions to the corresponding XML schema.

User feedback during an MBMS streaming session can be provisioned by simple extensions of the XML schema defined in MBMS for associated delivery procedures. The following is an example implementation of extensions to associated delivery procedures in MBMS.

A new element of the type userFeedbackType is introduced in the XML schema corresponding to the ‘Associated Delivery Procedures’ as shown in the sample code below. The required element(s) ‘serverURI’ specifies the URIs of the list of servers that collect the feedback from the clients. FIG. 2 illustrates the definition of ‘waitTime’ and ‘maxBackOff’ parameters. After collecting the feedback, the client waits for ‘waitTime’ time units and generates a random number ‘X’ between ‘0’ and ‘maxBackOff’. It sends the feedback after waiting for ‘X’ more time units. The feedback is sent reliably using HTTP/TCP.

```
<?xml version=“1.0” encoding=“UTF-8”?>
<xs:schema xmlns:xs=“http://www.w3.org/2001/XMLSchema” elementFormDefault=“qualified”>
  <xs:element name=“associatedProcedureDescription” type=“associatedProcedureType”/>
  <xs:complexType name=“associatedProcedureType”>
    <xs:sequence>
      <xs:element name=“postFileRepair” type=“basicProcedureType” minOccurs=“0”maxOccurs=“1”/>
      <xs:element name=“bmFileRepair” type=“ bmFileRepairType” minOccurs=“0” maxOccurs=“1”/>
      <xs:element name=“postReceptionReport” type=“reportProcedureType”minOccurs=“0” maxOccurs=“1”/>
      <xs:element name=“userFeedbackReport” type=“feedbackProcedureType”minOccurs=“0” maxOccurs=“1”/>
    </xs:sequence>
  </xs:complexType>
  <xs:complexType name=“basicProcedureType”>
    <xs:sequence>
      <xs:element name=“serverURI” type=“xs:anyURI” minOccurs=“1” maxOccurs=“unbounded”/>
    </xs:sequence>
    <xs:attribute name=“waitTime” type=“xs:unsignedLong” use=“optional”/>
    <xs:attribute name=“maxBackOff” type=“xs:unsignedLong” use=“required”/>
  </xs:complexType>
  <xs:complexType name=“bmFileRepairType”>
    <xs:attribute name=“sessionDescriptionURI” type=“xs:anyURI ” use=“required”/>
  </xs:complexType>
  <xs:complexType name=“repairProcedureType”>
    <xs:simpleContent>
      <xs:extension base=“basicProcedureType”>
        <xs:attribute name=“samplePercentage” type=“xs:string” use=“optional”/>
        <xs:attribute name=“forceTimingIndependence” type=“xs:boolean” use=“optional”/>
        <xs:attribute name=“reportType” type=“xs:string” use=“optional”/>
      </xs:extension>
    </xs:simpleContent>
  </xs:complexType>
“report-type” value = “rack” || “star” || “star-all”
  <xs:complexType name=“userFeedbackProcedureType”>
    <xs:simpleContent>
      <xs:extension base=“basicProcedureType”>
        <xs:attribute name=“feedbackReportType” type=“xs:string” use=“optional”/>
      </xs:extension>
    </xs:simpleContent>
  </xs:complexType>
</xs:schema>
feedbackReportType = {“yesNo” || “bestOne” || “ranking”}
```

The MBMS streaming server decides to collect certain types of feedback during the MBMS streaming session. Examples of the type of feedback can be ‘Yes/No vote’, ‘Best among a group of items (A/B/C/. . . )’, ‘Ranking’ etc. The client application collects the appropriate type of feedback at required time instants. The client application also formats the feedback into XML objects to be transported subsequently using a HTTP POST method.

The user may provide the same type of feedback at multiple time instants during an MBMS streaming session. The XML object corresponding to a client feedback may contain some means of uniquely identifying each feedback, such as, for example, the time-stamp corresponding to the time instant at which client feedback was collected. In some other embodiments, a feedback counter may be used to keep track of various feedback instances. Other useful information such as clientID, serverURI etc are optionally included in the XML object corresponding to the user feedback.

The XML schema corresponding to each type of feedback can be defined as shown in the following sample code. The client application formats the feedback into XML objects using this XML schema.

```
<?xml version=“1.0” encoding=“UTF-8”?>
<xs:schema xmlns:xs=“http://www.w3.org/2001/XMLSchema” elementFormDefault=“qualified”>
    <xs:element name=“userFeedbackReport”>
      <xs:choice>
      <xs:element name=“simpleYesNoVote” type=“yesNoType”/>
      <xs:element name=“bestAmongAGroup” type=“bestOneType”/>
      <xs:element name=“rankInASpecificOrder” type=“rankingType”/>
      </xs:choice>
    </xs:element>
<xs:complexType name=“yesNoType”>
    <xs:sequence>
        <xs:element name=“yesNoVote” type=“xs:boolean” minOccurs=“0”
maxOccurs=“1”/>
        <xs:element name=“timeStamp” type=“xs:string” minOccurs=“0”
maxOccurs=“1”/>
        <xs:attribute name=“sessionId” type=“xs:string” use=“optional”/>
    <xs:attribute name=“sessionType” type=“xs:string” use=“optional”/>
    <xs:attribute name=“serviceId” type=“xs:string” use=“optional”/>
    <xs:attribute name=“clientId” type=“xs:string” use=“optional”/>
    <xs:attribute name=“serverURI” type=“xs:anyURI” use=“optional”/>
    </xs:sequence>
</xs:complexType>
<xs:complexType name=“bestOneType”>
    <xs:simpleContent>
      <xs:element name=“bestOneVote” type=“xs:string” minOccurs=“0” maxOccurs=“1”/>
      <xs:element name=“timeStamp” type=“xs:string” minOccurs=“0” maxOccurs=“1”/>
      <xs:attribute name=“sessionId” type=“xs:string” use=“optional”/>
      <xs:attribute name=“sessionType” type=“xs:string” use=“optional”/>
      <xs:attribute name=“serviceId” type=“xs:string” use=“optional”/>
      <xs:attribute name=“clientId” type=“xs:string” use=“optional”/>
      <xs:attribute name=“serverURI” type=“xs:anyURI” use=“optional”/>
    </xs:simpleContent>
</xs:complexType>
    <xs:complexType name=“rankingType”>
      <xs:simpleContent>
      <xs:element name=“rankString” type=“xs:string” minOccurs=“0” maxOccurs=“1”/>
      <xs:element name=“timeStamp” type=“xs:string” minOccurs=“0” maxOccurs=“1”/>
      <xs:attribute name=“sessionId” type=“xs:string” use=“optional”/>
      <xs:attribute name=“sessionType” type=“xs:string” use=“optional”/>
      <xs:attribute name=“serviceId” type=“xs:string” use=“optional”/>
      <xs:attribute name=“clientId” type=“xs:string” use=“optional”/>
      <xs:attribute name=“serverURI” type=“xs:anyURI” use=“optional”/>
      </xs:simpleContent>
      </xs:complexType>
    </xs:complexType>
</xs:schema>
```

The XML objects corresponding to multiple feedback instances may be aggregated using multipart-MIME structure.

The following is an example RTCP (real-time control protocol) feedback reports implementation. A sender to request feedback from a plurality of receivers, via the sending of a feedback token on the service announcement channel (SDP, XML, FLUTE, etc.) out-of-band in downlink direction, or in-band in downlink direction within the RTP or RTCP stream (for example by using an RTP header extension with an appropriate field, or an RTCP APP packet with an extension with an appropriate field). The field contains an indicator of feedback (indicating that the feedback is requested), and optionally a time indicator (indicating when the feedback is requested), and a number indicating the fraction of receivers that are requested to send the feedback.

The receivers extract a random number and if the number is less than or equal than the number indicating the fraction of receivers (received by the sender), sends an RTCP report (or any other quality report) immediately or using the timing rule which is communicated by the sender to the receivers.

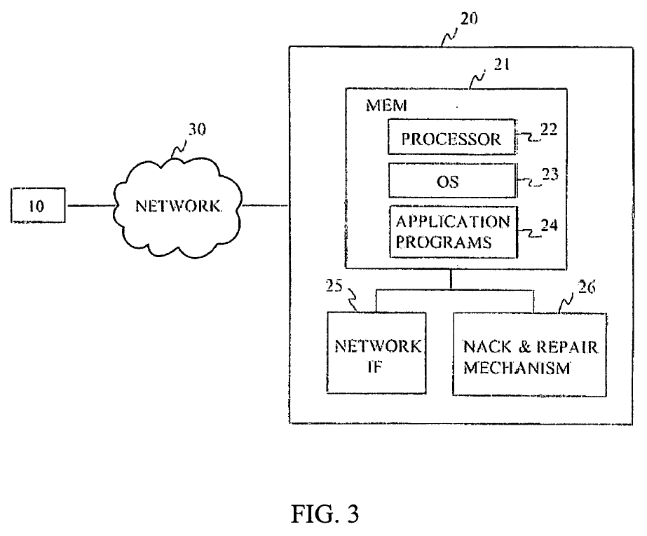

FIG. 3 illustrates receiver device 20 in accordance with an exemplary embodiment. A communication system includes the sender device 10 a transmission network 30, e.g., an IP network or another fixed network, a wireless network or a combination of a fixed and a wireless (cellular) network etc., and the receiver device 20. The receiver device 20 can be a cellular telephone, a satellite telephone, a personal digital assistant or a Bluetooth device, WLAN device, DVB device, or other similar wireless device. The device 20 includes an internal memory 21, a processor 22, an operating system 23, application programs 24, a network interface 25 and a NACK & repair mechanism 26. The internal memory 21 accommodates the processor 22, operating system 23 and application programs 24. The NACK & repair mechanism 26 enables the NACKing and repair procedures in response to missing or mangled data in a data transmission. The device 20 is able to communicate with the sender device 10 and other devices via the network interface 25 and the network 30.

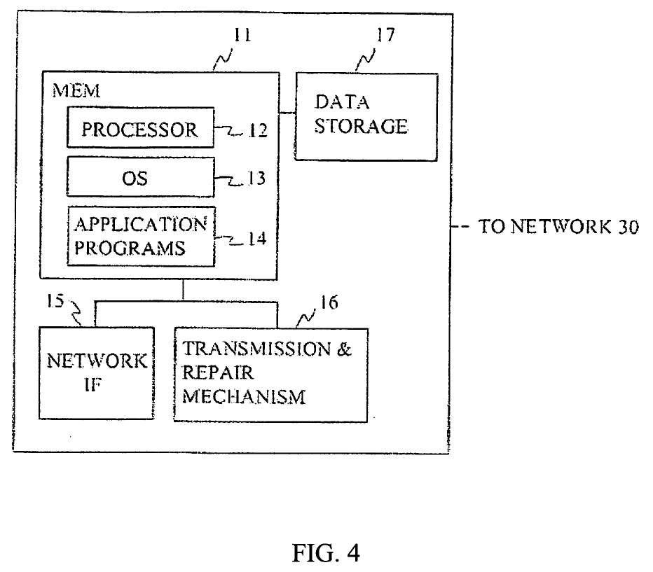

FIG. 4 illustrates sender device 10 in accordance with an exemplary embodiment. The sender device 10 can be, for example, a network server or any suitable device intended for file (or media) delivery. The device 10 includes an internal memory 11, a processor 12, an operating system 13, application programs 14, a network interface 15, a transmission & repair mechanism 16 and a data storage 17. The internal memory 11 accommodates the processor 12, operating system 13 and application programs 14. The transmission & repair mechanism 16 enables the transmission of data packets to receiver device(s) 20. Furthermore, it enables re-transmission of data packets in repair sessions. Data to be sent to receiver devices 20 and data to be re-transmitted can be stored in the data storage 17. Alternatively, data can be stored in a separate device co-located with or outside of the sender device 10. The device 10 is able to communicate with the receiver device 20 and other devices via the network interface 15 and the network 30.

While several embodiments of the invention have been described, it is to be understood that modifications and changes will occur to those skilled in the art to which the invention pertains. Accordingly, the claims appended to this specification are intended to define the invention precisely.

1. A method of providing scalable feedback during point-to-multicast (PtM) streaming sessions, the method comprising:
communicating data from a sender to at least one receiver; and
communicating feedback from at least one of the at least one receiver to the sender during a multimedia streaming session.

2. The method of claim 1, further comprising prompting the at least one receiver for input.

3. The method of claim 2, further comprising providing parameters for collecting input from the at least one receiver and a maximum back off time for random time dispersion.

4. The method of claim 2, further comprising provisioning input from the at least one receiver during the multimedia streaming session using extensions of associated delivery procedures.

5. The method of claim 2, wherein the prompting for input from the at least one receiver involves sending a token on a service announcement channel.

6. The method of claim 5, further comprising extracting a random number from the at least one receiver and sending a quality report if the random number is less than or equal a number indicating the fraction of receivers communicating to the sender.

7. A system for providing scalable feedback during point-to-multicast (PtM) streaming sessions, the system comprising:
a sending device that initiates a multimedia session and communicates multimedia data via a communication network during a multimedia streaming session; and
a receiving device that communicates feedback to the multimedia data during the PtM multimedia streaming session in response to a prompt.

8. A computer program product utilized in multimedia broadcast streaming, the computer program product comprising:
computer code to communicate data from a sender to at least one receiver; and
computer code to communicate feedback from at least one of the at least one receiver to the sender during a point-to-multicast multimedia streaming session.

9. A device that communicates in multimedia sessions over a network, the device comprising:
a processor that executes instructions to communicate multimedia data to at least one receiver; and
a memory that stores input collected from the at least one receiver and a maximum back off time for random time dispersion during a point-to-multicast multimedia streaming session.

10. A device that communicates in multimedia sessions over a network, the device comprising:
a processor that receives multimedia data from a sending device; and
programmed instructions that provide for the communication of input responsive to the received multimedia data during a point-to-multicast multimedia streaming session.
